(19) United States
(12) Patent Application Publication
(10) Pub. No.: US 2026/0146940 A1
(43) Pub. Date: May 28, 2026

(54) FLUORESCENCE ANALYSIS DEVICE AND FLUORESCENCE ANALYSIS METHOD

(71) Applicant: HAMAMATSU PHOTONICS K.K., Hamamatsu-shi (JP)

(72) Inventors: Tomomi KUBO, Shizuoka (JP); Yoshiaki YAMAUCHI, Shizuoka (JP); Koji TAKEMIYA, Shizuoka (JP); Yasumasa MATSUOKA, Shizuoka (JP); Shunsuke KOBAYASHI, Shizuoka (JP)

(73) Assignee: HAMAMATSU PHOTONICS K.K., Hamamatsu-shi (JP)

(21) Appl. No.: 19/398,363

(22) Filed: Nov. 24, 2025

(30) Foreign Application Priority Data
Nov. 27, 2024 (JP) 2024-206172

(51) Int. Cl. G01N 15/1434; G01N 15/10

(52) U.S. Cl. CPC G01N 15/1434; G01N 2015/1006

(57) ABSTRACT

A fluorescence analysis device for discriminating samples in accordance with a type of fluorescent dye labeled by analyzing measurement data before an arithmetic process obtained by detecting fluorescence generated when a plurality of samples labeled with any of a plurality of fluorescent dyes are each irradiated with excitation light by a plurality of detection channels comprises a first determination unit configured to determine whether or not the plurality of samples can be separated into two or more populations based on the measurement data by any one or more of the plurality of detection channels; and a first separation unit configured to separate one population from the two or more populations when the first determination unit determines that the plurality of samples can be separated into the two or more populations.

### TECHNICAL FIELD

The present disclosure relates to a fluorescence analysis device and a fluorescence analysis method.

### BACKGROUND

Fluorescence analysis techniques for discriminating a plurality of samples labeled with any of several fluorescent dyes according to the type of fluorescent dye are important, for example, in flow cytometry (FCM). In FCM, it is possible to discriminate samples by detecting an intensity of fluorescence or scattered light generated when a large number of fluorescently labeled samples (e.g., cells and other microparticles) are aligned one by one to flow through a channel and each sample flowing through the channel is irradiated with laser light, and analyzing measurement data obtained through such detection.

In FCM, a plurality of types of fluorescent dyes that are specifically coupled to samples belonging to specific populations are used, and each of the plurality of samples is labeled with any of the plurality of fluorescent dyes to acquire measurement data by detecting the intensity of fluorescence generated by laser irradiation of each sample. In this fluorescence detection, the intensity of fluorescence in each wavelength band is measured using a detection device with a plurality of detection channels, each of which selectively detects fluorescence in a specific wavelength band. Such a measurement is referred to as a multicolor measurement. When an analysis is performed based on this measurement data, it is possible to discriminate samples in accordance with a type of fluorescent dye labeled, i.e., it is possible to discriminate samples according to each population. Such an analysis is referred to as a multicolor analysis.

During multicolor measurement, fluorescence generated by a certain type of fluorescent dye may be detected by the detection channel provided in correspondence with the type of fluorescent dye or may be detected by one or more other detection channels corresponding to other types of fluorescent dyes. This phenomenon is referred to as fluorescence spillover. When fluorescence spillover occurs, even if a sample is essentially labeled with one type of fluorescent dye, the measurement data will appear to be labeled with other types of fluorescent dyes, resulting in errors in the results of multicolor analysis using this measurement data. To solve this problem, before sample discrimination, an arithmetic process for subtracting the spillover fluorescence intensity from the fluorescence measurement data obtained by detection using each detection channel, such as fluorescence compensation as described in Japanese Unexamined Patent Publication No. 2011-232254 and Japanese Unexamined Patent Publication No. 2011-232259, or fluorescence intensity calculation (fluorescence unmixing) as described in Japanese Patent No. 7564408, is performed.

### SUMMARY

An arithmetic process for solving the problem of fluorescence spillover may increase the variation of the measurement data, resulting in poor analysis accuracy. In other words, a plurality of samples labeled with one type of fluorescent dye are displayed as a population in a cytogram in which measurement data obtained by detection with each of two detection channels is plotted on a two-dimensional map. When there is fluorescence spillover, the population on the cytogram appears as if samples labeled with one fluorescent dye may also be labeled with other fluorescent dyes. Although the population on the cytogram appears as if it is labeled with a single type of fluorescent dye if the arithmetic process is performed, the arithmetic process increases the variation of the measurement data, so that the population will be distributed over a wider area than before the arithmetic process. When there are two populations on a cytogram, even if these two populations are displayed as separable from each other before the arithmetic process, it may be difficult to separate the two populations from each other because they are distributed over a wide area after the arithmetic process. This may result in poor analysis accuracy. These problems become more pronounced as more types of fluorescent dyes are used.

The present disclosure has been made to solve the above problems and an objective of the present disclosure is to provide a device and a method that can perform highly accurate fluorescence analysis even if many types of fluorescent dyes are used.

A fluorescence analysis device of the present disclosure is a device for discriminating samples in accordance with a type of fluorescent dye labeled by analyzing measurement data before an arithmetic process obtained by detecting fluorescence generated when a plurality of samples labeled with any of a plurality of fluorescent dyes are each irradiated with excitation light by a plurality of detection channels.

A first aspect of the fluorescence analysis device of the present disclosure comprises (1) a first determination unit configured to determine whether or not the plurality of samples can be separated into two or more populations based on the measurement data by any one or more of the plurality of detection channels; and (2) a first separation unit configured to separate one population from the two or more populations when the first determination unit determines that the plurality of samples can be separated into the two or more populations. Also, a process of each of the first determination unit and the first separation unit is iteratively performed for a plurality of samples other than an already discriminated sample until the first determination unit determines that the plurality of samples cannot be separated into the two or more populations and a sample included in a population whose separation is determined to be impossible is discriminated as a sample labeled with any fluorescent dye.

In addition to the first aspect, a second aspect of the fluorescence analysis device of the present disclosure may further comprise (3) a second determination unit configured to determine whether or not a plurality of samples included in a separated population can be further separated into two or more populations based on measurement data of any one or more of the plurality of detection channels; and (4) a second separation unit configured to separate one population from the two or more populations when the second determination unit determines that the plurality of samples can be separated into the two or more populations. Also, a process of each of the second determination unit and the second separation unit may be iteratively performed for a plurality of samples other than an already discriminated sample until the second determination unit determines that the plurality of samples cannot be separated into the two or more populations and a sample included in a population whose separation is determined to be impossible may be discriminated as a sample labeled with any fluorescent dye.

In addition to the first or second aspect, a third aspect of the fluorescence analysis device of the present disclosure may further include an identification unit configured to perform an identification process based on a fluorescence spectrum obtained from the measurement data by the plurality of detection channels for a sample discriminated to be labeled with any fluorescent dye.

In addition to any one of the first to third aspects, in a fourth aspect of the fluorescence analysis device of the present disclosure, the first determination unit may perform the determination based on the measurement data obtained by detecting the fluorescence generated when each of a plurality of samples labeled with any of a plurality of fluorescent dyes is irradiated with excitation light of a plurality of wavelengths by a plurality of detection channels.

In addition to any one of the first to fourth aspects, in a fifth aspect of the fluorescence analysis device of the present disclosure, the first determination unit may perform the determination after a binning process is performed on the measurement data.

A fluorescence analysis method of the present disclosure is a method for discriminating samples in accordance with a type of fluorescent dye labeled by analyzing measurement data before an arithmetic process obtained by detecting fluorescence generated when a plurality of samples labeled with any of a plurality of fluorescent dyes are each irradiated with excitation light by a plurality of detection channels.

A first aspect of the fluorescence analysis method of the present disclosure comprises (1) a first determination step of determining whether or not the plurality of samples can be separated into two or more populations based on the measurement data by any one or more of the plurality of detection channels; and (2) a first separation step of separating one population from the two or more populations when it is determined that the plurality of samples can be separated into the two or more populations in the first determination step. Also, the first determination step and the first separation step are iteratively performed for a plurality of samples other than an already discriminated sample until it is determined that the plurality of samples cannot be separated into the two or more populations in the first determination step and a sample included in a population whose separation is determined to be impossible is discriminated as a sample labeled with any fluorescent dye.

In addition to the first aspect, a second aspect of the fluorescence analysis method of the present disclosure may further comprise (3) a second determination step of determining whether or not a plurality of samples included in a separated population can be further separated into two or more populations based on measurement data of any one or more of the plurality of detection channels; and (4) a second separation step of separating one population from the two or more populations when the second determination step determines that the plurality of samples can be separated into the two or more populations. Also, the second determination step and the second separation step may be iteratively performed for a plurality of samples other than an already discriminated sample until it is determined that the plurality of samples cannot be separated into the two or more populations in the second determination step and a sample included in a population whose separation is determined to be impossible may be discriminated as a sample labeled with any fluorescent dye.

In addition to the first or second aspect, the third aspect of the fluorescence analysis method of the present disclosure may further comprise an identification step of performing an identification process based on a fluorescence spectrum obtained from the measurement data by the plurality of detection channels for a sample discriminated to be labeled with any fluorescent dye.

In addition to any one of the first to third aspects, in a fourth aspect of the fluorescence analysis method of the present disclosure, the first determination step may include performing the determination based on the measurement data obtained by detecting the fluorescence generated when each of a plurality of samples labeled with any of a plurality of fluorescent dyes is irradiated with excitation light of a plurality of wavelengths by a plurality of detection channels.

In addition to any one of the first to fourth aspects, in a fifth aspect of the fluorescence analysis method of the present disclosure, the first determination step may include performing the determination after a binning process is performed on the measurement data.

According to the present disclosure, highly accurate fluorescence analysis can be performed even if many types of fluorescent dyes are used.

### BRIEF DESCRIPTION OF THE DRAWINGS

FIG. 1 is a block diagram showing a configuration of a fluorescence analysis device.

FIG. 2 is an example of a flowchart of a fluorescence analysis method.

FIG. 3 is another example of the flowchart of the fluorescence analysis method.

FIG. 4 is a diagram showing an example of a fluorescence spectrum of each of fluorescent dyes A to C.

FIG. 5 is a diagram schematically showing four types of samples.

FIG. 6 is a diagram showing a cytogram of the measurement data in a first cycle.

FIG. 7 is a diagram showing a cytogram of measurement data of population X (population A) separated in the first cycle.

FIG. 8A is a diagram showing a fluorescence spectrum of each of four populations A to D. FIG. 8B is a diagram showing a fluorescence spectrum of only the separated population A. FIG. 8C is a diagram showing fluorescence spectra of other populations B to D.

FIG. 9A is a diagram showing a distribution of a case where a plurality of populations including population X in cytogram C1 for ch2 and ch7 are classified into four populations A to D and displayed. FIG. 9B is a diagram showing a distribution of only population X (population A) in cytogram C1 for ch2 and ch7. FIG. 9C is a diagram showing a distribution of a case where the other populations in cytogram C1 for ch2 and ch7 are classified into populations B to D and displayed.

FIG. 10 is a diagram showing a cytogram of the measurement data in a second cycle (except for the measurement data of population A, which has already been separated).

FIG. 11 is a diagram showing a cytogram of the measurement data of population Y (population D) separated in the second cycle.

FIG. 12A is a diagram showing fluorescence spectra of three populations B to D. FIG. 12B is a diagram showing a fluorescence spectrum of only the separated population D. FIG. 12C is a diagram showing fluorescence spectra of other populations B and C.

FIG. 13A is a diagram showing a distribution of a case where a plurality of populations including population Y in cytogram C2 for ch6 and ch7 are classified into three populations B to D and displayed. FIG. 13B is a diagram showing a distribution of only population Y (population D) in cytogram C2 for ch6 and ch7. FIG. 13C is a diagram showing a distribution of a case where the other populations in cytogram C2 for ch6 and ch7 are classified into populations B and C and displayed.

FIG. 14 is a diagram showing a cytogram of measurement data in a third cycle (except for the measurement data of populations A and D, which have already been separated).

FIG. 15 is a diagram showing a cytogram of measurement data of one population (population C) separated in the third cycle.

FIG. 16A is a diagram showing fluorescence spectra of two populations B and C. FIG. 16B is a diagram showing a fluorescence spectrum of the separated population C only. FIG. 16C is a diagram showing a fluorescence spectrum of the other population B.

FIG. 17A is a diagram showing a distribution of a case where two populations in cytogram C3 for ch5 and ch6 are classified into populations B and C and displayed. FIG. 17B is a diagram showing a distribution of only one population (population C) in cytogram C3 for ch5 and ch6. FIG. 17C is a diagram showing a distribution of the other population (population B) in cytogram C3 for ch5 and ch6.

FIG. 18 is a diagram showing a cytogram of measurement data in a fourth cycle (except for the measurement data of populations A, C, and D, which have already been separated).

FIG. 19 is a diagram showing a cytogram of the measurement data in the second cycle (except for the measurement data of population X (population A), which has already been separated).

FIG. 20 is a diagram showing a cytogram of measurement data of a separated population (one apparent population Z including populations B and C) in the second cycle.

FIG. 21A is a diagram showing a distribution of a case where a plurality of populations in cytogram C4 for ch2 and ch7 are classified into three populations B to D and displayed. FIG. 21B is a diagram showing a distribution of one apparent population Z including populations B and C in cytogram C4 for ch2 and ch7.

FIGS. 22A to 22F are diagrams showing fluorescence spectra of six separated populations.

FIGS. 23A to 23D are explanatory diagrams of a method and results of identifying samples included in the population showing the fluorescence spectrum of FIG. 22A according to a fitting process.

FIGS. 24A to 24D are explanatory diagrams of results of identifying samples included in a population showing the fluorescence spectra of FIGS. 22B to 22E according to a fitting process.

### DETAILED DESCRIPTION

Embodiments for implementing the present invention will be described in detail below with reference to the accompanying drawings. In description of the drawings, the same reference signs denote the same elements, and redundant description thereof will be omitted. The present disclosure is not limited to these examples, but is indicated by the claims, which are intended to include all modifications within the meaning and scope equivalent to the claims.

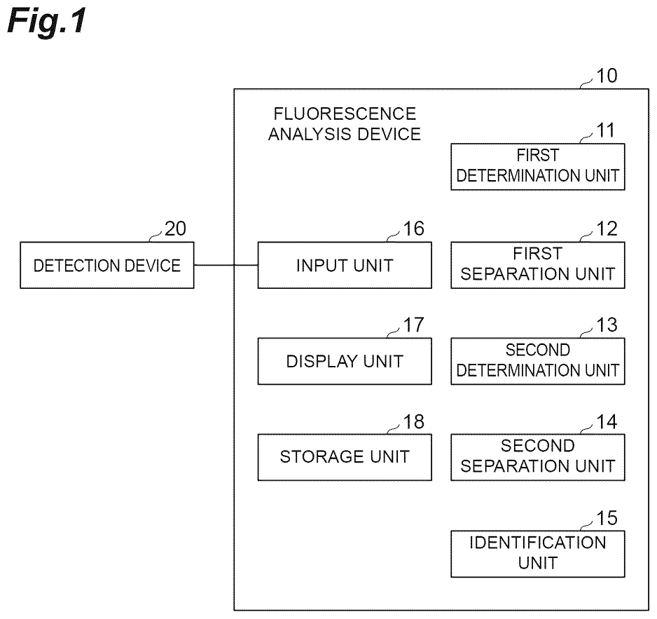

FIG. 1 is a block diagram showing a configuration of a fluorescence analysis device 10. The fluorescence analysis device 10 constitutes a flow cytometer together with the detection device 20.

The detection device 20 aligns a large number of fluorescently labeled samples (e.g., cells and other small particles) one by one so that the samples flow through a channel, detects an intensity of fluorescence or scattered light generated when each sample flowing through the channel is irradiated with laser light (excitation light), and acquires measurement data obtained through such detection. The detection device 20 has a plurality of detection channels that selectively detect fluorescence in respective specific wavelength bands. The plurality of detection channels for fluorescence detection as a whole may be capable of detecting a continuous fluorescence spectrum or a fluorescence spectrum excluding some bands. The detection device 20 also has a scattered light detection channel for detecting side scatter (SSC) and forward scatter (FSC), generated when the laser light is radiated. The laser light may have a plurality of wavelengths.

The fluorescence analysis device 10 inputs the measurement data acquired by the detection device 20 and analyzes the measurement data before the arithmetic process to discriminate samples in accordance with the type of fluorescent dye labeled. The fluorescence analysis device 10 may be a computer. The fluorescence analysis device 10 includes a first determination unit 11, a first separation unit 12, a second determination unit 13, a second separation unit 14, an identification unit 15, an input unit 16, a display unit 17, and a storage unit 18.

The input unit 16 inputs measurement data acquired by the detection device 20 as well as analysis conditions. The display unit 17 displays a state during the analysis and an analysis result on the screen. A display form of the display unit 17 is optional and may be, for example, a cytogram or histogram. The storage unit 18 stores the measurement data before the arithmetic process input from the detection device 20, as well as data during the analysis and data at the end of analysis. Moreover, the storage unit 18 stores programs for executing the processes of the first determination unit 11, the first separation unit 12, the second determination unit 13, the second separation unit 14, and the identification unit 15. The processes of the first determination unit 11, the first separation unit 12, the second determination unit 13, the second separation unit 14, and the identification unit 15 will be described below.

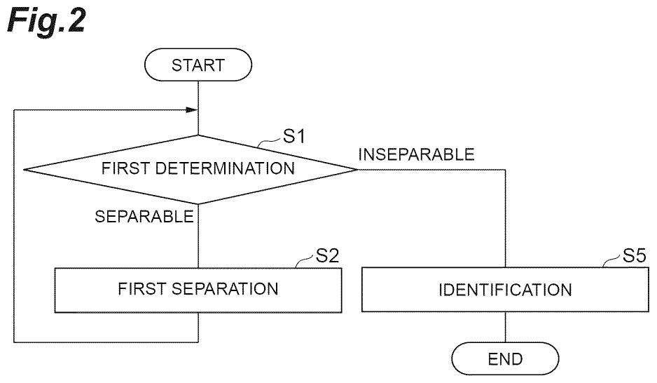

FIG. 2 is an example of a flowchart of a fluorescence analysis method. In the flowchart shown in this drawing, the fluorescence analysis method has a first determination step S1, a first separation step S2, and an identification step S5. The first determination step S1 is a process performed by the first determination unit 11. The first separation step S2 is a process performed by the first separation unit 12. The identification step S5 is a process performed by the identification unit 15. In this fluorescence analysis method, the fluorescence analysis device 10 does not need to include the second determination unit 13 and the second separation unit 14.

In the first determination step S1, the first determination unit 11 determines whether or not the plurality of samples flowing through the channel can be separated into two or more populations based on the measurement data by any one or more of the plurality of detection channels that the detection device 20 has. In the first separation step S2, the first separation unit 12 separates any one of the two or more populations if the first determination unit 11 determines that they can be separated into two or more populations.

Until it is determined that the samples cannot be separated into two or more populations in the first determination step S1, the processes of the first determination step S1 and the first separation step S2 are iteratively performed for a plurality of samples excluding those already discriminated. Discriminate samples in the population determined to be inseparable as samples labeled with any of the fluorescent dyes.

In the identification step S5, the identification unit 15 identifies the sample discriminated as labeled with any of the fluorescent dyes, based on the fluorescence spectra obtained from the measurement data by the plurality of detection channels.

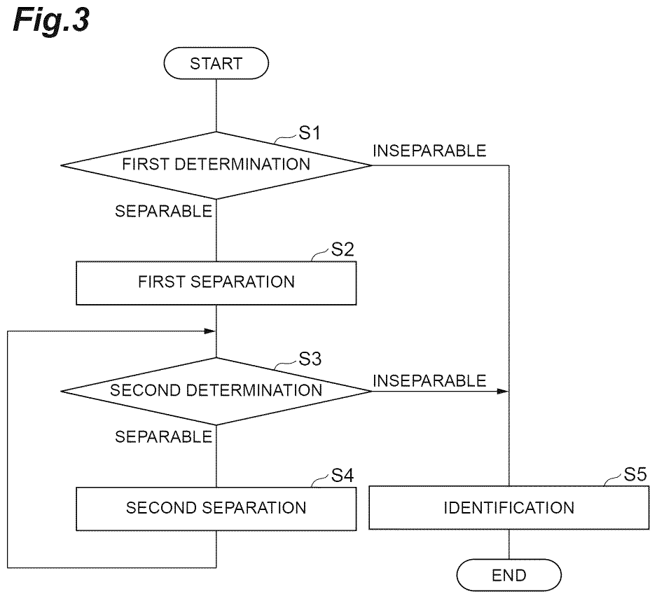

FIG. 3 is another example of the flowchart of the fluorescence analysis method. In the flowchart shown in this drawing, the fluorescence analysis method has a second determination step S3 and a second separation step S4 in addition to the first determination step S1, the first separation step S2, and the identification step S5. The second determination step S3 is a process performed by the second determination unit 13. The second separation step S4 is performed by the second separation unit 14.

In the second determination step S3, the second determination unit 13 determines whether the plurality of samples included in the population separated by the first separation unit 12 or the second separation unit 14 can be further separated into two or more populations based on the measurement data by any one or more of the plurality of detection channels In the second separation step S4, the second separation unit 14 separates any one of those populations when the second determination unit 13 determines that they can be further separated into two or more populations.

Until it is determined that the samples cannot be separated into two or more populations in the second determination step S3, the processes of the second determination step S3 and the second separation step S4 are iteratively performed for a plurality of samples, excluding those that have already been discriminated. When it is determined that the population cannot be separated into two or more populations in the second determination step S3, identification is performed in the identification step S5. In other words, the samples in the population that are determined to be inseparable are discriminated as samples labeled with any of the fluorescent dyes.

The flowchart of the fluorescence analysis method shown in FIGS. 2 and 3 is only an example; other forms of fluorescence analysis method flowcharts are also possible. In the identification step S5, each time a population is determined to be inseparable by the first determination step S1 or the second determination step S3, the samples in the population may be identified. When it is determined that the population cannot be separated into two or more populations in the second determination step S3, the process may return to the first determination step S1 instead of performing the identification in the identification step S5 and different populations may be re-selected. In the first determination step S1 or the second determination step S3, the determination may be performed after a binning process is performed on the measurement data. When one population is separated from other populations in the cytogram display, any threshold may be set. For example, if the threshold is set to 0 counts, a region that can be surrounded by 0 counts and has no other populations inside is defined, and one population within the region is separated.

Each of the first determination step S1, the first separation step S2, the second determination step S3, and the second separation step S4 may be performed based on a cytogram, histogram, or the like displayed on the display unit 17, or may be performed automatically by numerical calculation without being displayed on the display unit 17. When cytograms, histograms, and the like are displayed on the display unit 17, the determination and separation may be performed automatically, or the operator may manually operate the determination and separation. When determinations and separations are performed automatically by numerical calculation, unsupervised machine learning methods can be used to perform determinations and separations without prior knowledge of the measurement data.

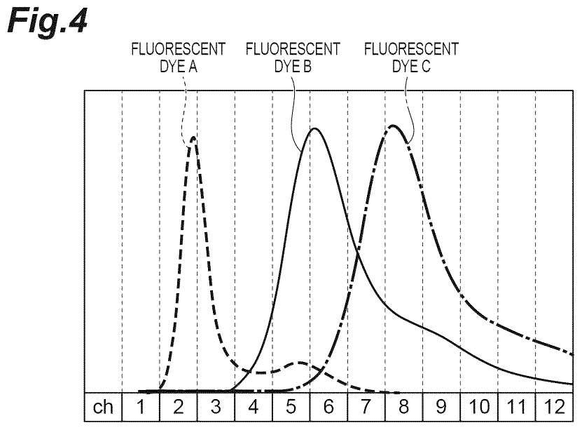

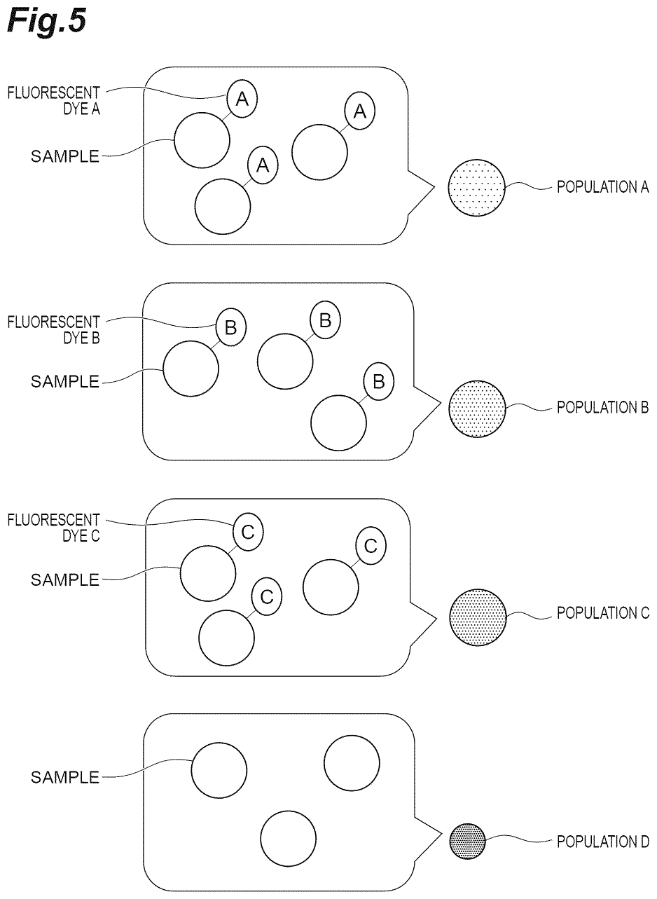

Next, the fluorescence analysis method shown in FIG. 2 will be further described using FIGS. 4 to 18. Here, the number of detection channels for fluorescence detection is set to 12, and the 12 detection channels are designated as ch1 to ch12 in order from the short wavelength side. It is assumed that three fluorescent dyes A to C are used. FIG. 4 is a diagram showing an example of a fluorescence spectrum of each of fluorescent dyes A to C. It is assumed that there are four types of samples, i.e., a sample labeled with one fluorescent dye A, a sample labeled with one fluorescent dye B, a sample labeled with one fluorescent dye C, and a sample that is not labeled with any fluorescent dye. FIG. 5 is a diagram schematically showing the four types of samples. Hereafter, the population of samples labeled with one fluorescent dye A is referred to as population A, the population of samples labeled with one fluorescent dye B is referred to as population B, the population of samples labeled with one fluorescent dye C is referred to as population C, and the population of samples that are not labeled with any fluorescent dye is referred to as population D. In reality, the relationship between each population and the fluorescent dye cannot be determined unless identification is performed in identification step S5. However, for simplicity of description, the following description will be given by linking the notations in the cytogram to the above-mentioned populations A to D.

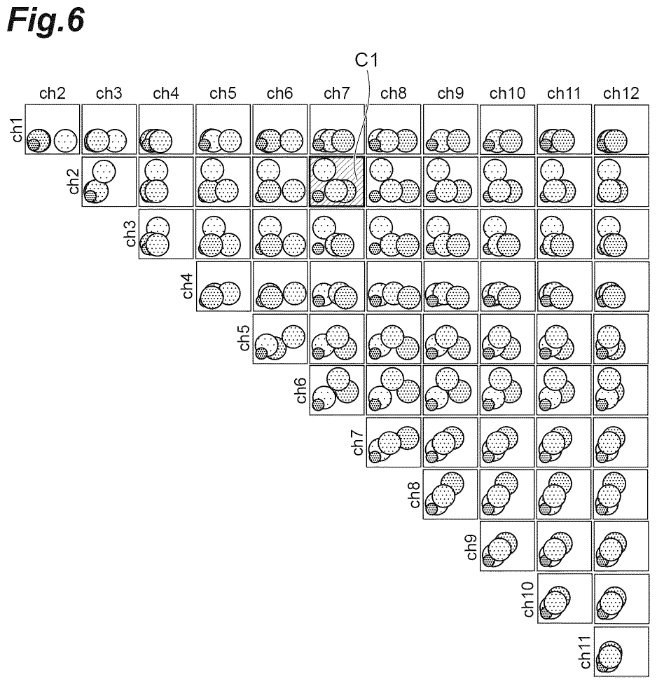

FIGS. 6 to 9C are explanatory diagrams of a process of a first cycle within the iterative processing of the first determination step S1 and the first separation step S2.

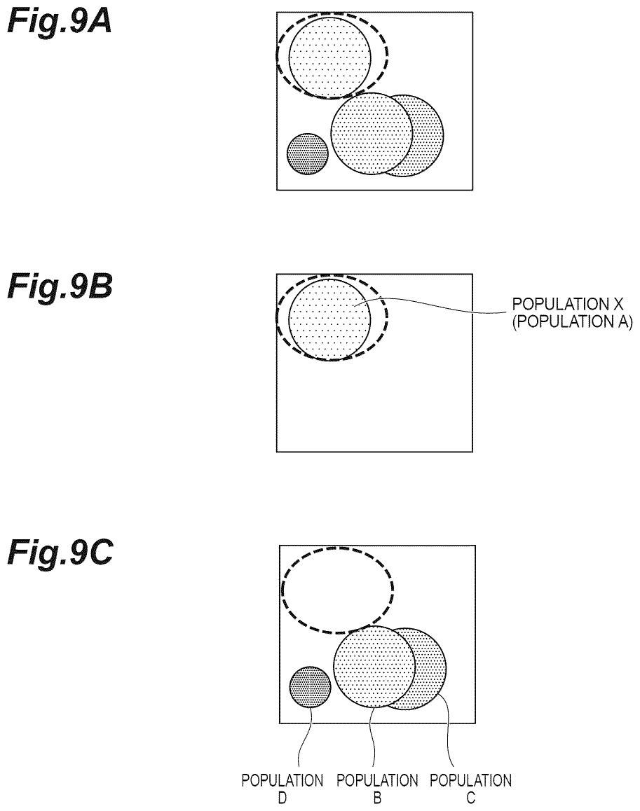

FIG. 6 shows a cytogram of the measurement data before the arithmetic process. In the actual cytogram, as shown in this drawing, how the four populations overlap is not explicitly indicated, but is simply shown as a shading diagram. However, as described above, the four populations A to D are explicitly indicated hereinafter for simplicity of description. This drawing shows cytograms for all combinations of two detection channels selected from among the 12 detection channels. As shown in this drawing, on many cytogram displays, any two or more of the four populations (here populations A to D) overlap each other, making it impossible to separate the four populations individually. However, in the display of a cytogram (e.g., in FIG. 6, cytogram C1 in which the measurement data for ch2 and ch7 is plotted on a two-dimensional map), one population X (here population A) and the other populations (here populations B to D) do not overlap each other and can be separated from each other (FIGS. 9A to 9C). Therefore, in the first determination step S1, it is determined that the population X can be separated from the other populations on the display of the cytograms for ch2 and ch7. Also, in the first separation step S2, population X is separated from the four populations.

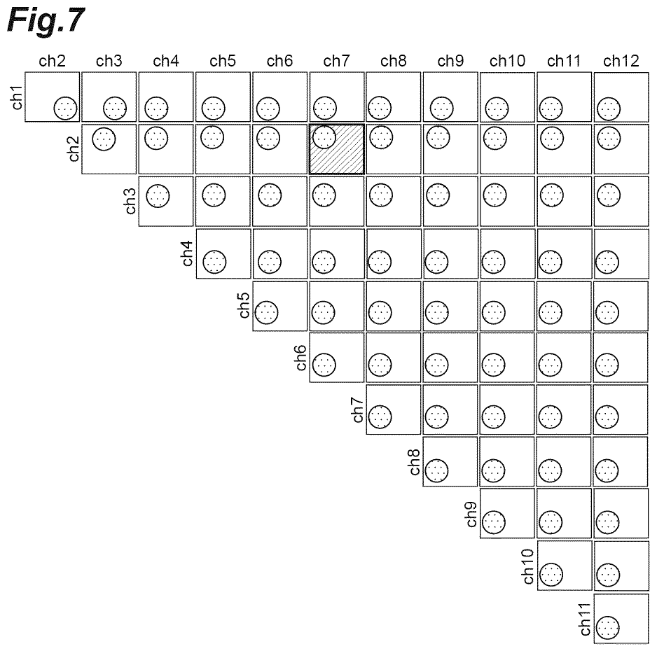

FIG. 7 is a diagram showing a cytogram of measurement data of the separated population X. This drawing also shows cytograms for all combinations of two detection channels selected from among the 12 detection channels. On the display of these cytograms, it is possible to confirm that there is only one population X (in this case, population A), because there is no recognition of the presence of more than one population.

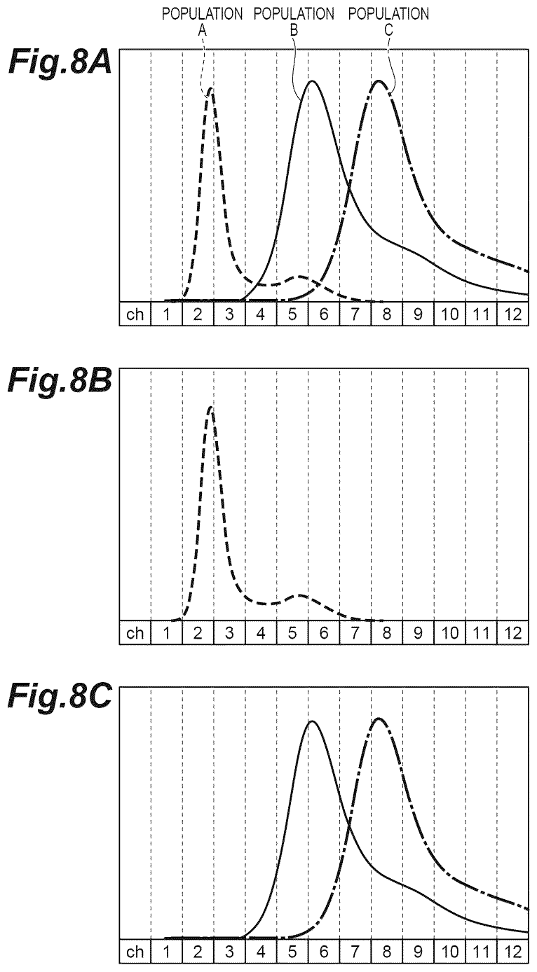

FIG. 8A is a diagram showing a fluorescence spectrum of each of four populations A to D. FIG. 8B is a diagram showing a fluorescence spectrum of only the separated population A. FIG. 8C is a diagram showing fluorescence spectra of other populations B to D. FIG. 9A is a diagram showing a distribution of a case where a plurality of populations including population X in cytogram C1 for ch2 and ch7 are classified into four populations A to D and displayed. FIG. 9B is a diagram showing a distribution of only population X (population A) in cytogram C1 for ch2 and ch7. FIG. 9C is a diagram showing a distribution of a case where the other populations in cytogram C1 for ch2 and ch7 are classified into populations B to D and displayed.

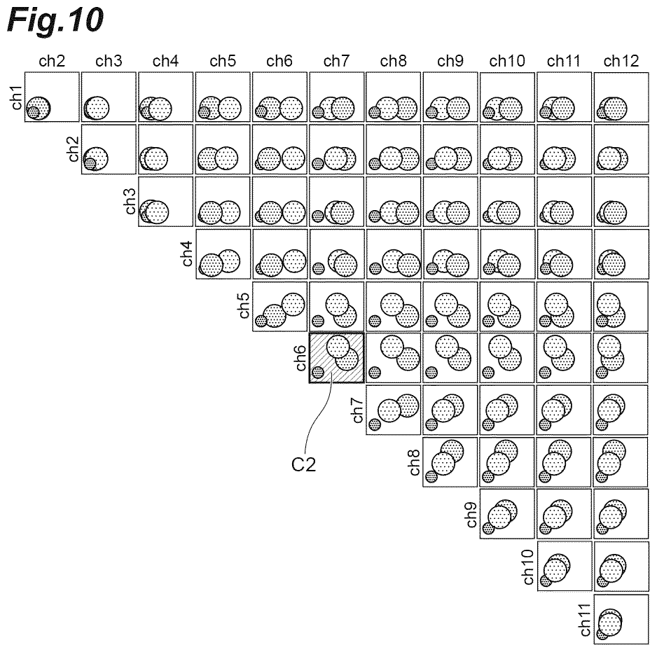

FIGS. 10 to 13C are explanatory diagrams of a process of the second cycle within the iterative processing of the first determination step S1 and the first separation step S2.

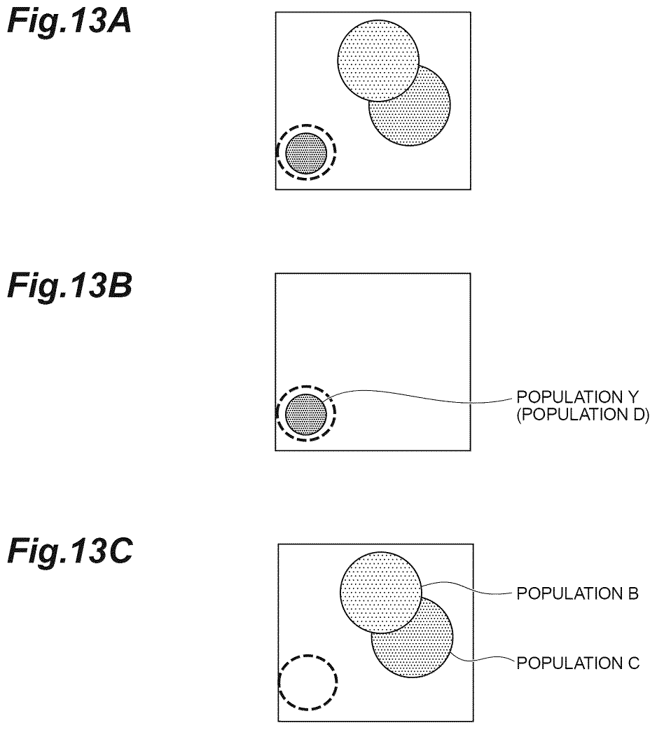

FIG. 10 is a diagram showing a cytogram of the measurement data before the arithmetic process (except for the measurement data of population X (population A), which has already been separated). This drawing also shows cytograms for all combinations of two detection channels selected from among the 12 detection channels. As shown in this drawing, on many cytogram displays, any two or more of the three populations (here populations B to D) overlap each other, making it impossible to separate the three populations individually. However, in the display of a cytogram (e.g., in FIG. 10, cytogram C2 in which the measurement data for ch6 and ch7 is plotted on a two-dimensional map), one population Y (here population D) and the other populations (here populations B and C) do not overlap each other and can be separated from each other (FIGS. 13A to 13C). Therefore, in the first determination step S1, it is determined that the population Y can be separated from the other populations on the display of the cytograms for ch6 and ch7. Also, in the first separation step S2, population Y is separated from the three populations.

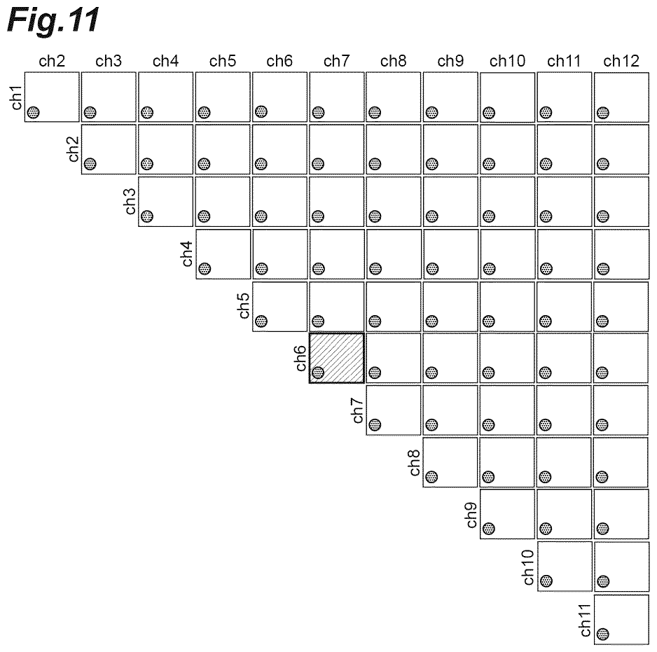

FIG. 11 is a diagram showing a cytogram of the measurement data of the separated population Y. This drawing also shows cytograms for all combinations of two detection channels selected from among the 12 detection channels. On the display of these cytograms, it is possible to confirm that there is only one population Y (in this case, population D), because there is no recognition of the presence of a plurality of populations.

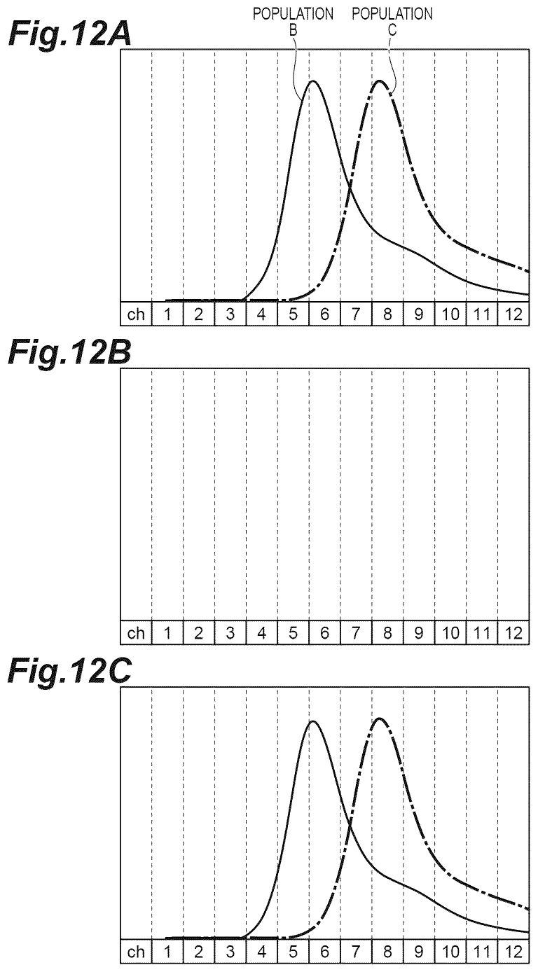

FIG. 12A is a diagram showing fluorescence spectra of three populations B to D. FIG. 12B is a diagram showing a fluorescence spectrum of only the separated population D. In this regard, because the samples in population D are not fluorescently labeled, the fluorescence from the samples in population D is autofluorescence from the samples, not from the target fluorescent dyes. For simplicity of description, it is assumed that autofluorescence is not considered in the present embodiment. FIG. 12C is a diagram showing fluorescence spectra of other populations B and C. FIG. 13A is a diagram showing a distribution of a case where a plurality of populations including population Y in cytogram C2 for ch6 and ch7 are classified into three populations B to D and displayed. FIG. 13B is a diagram showing a distribution of only population Y (population D) in cytogram C2 for ch6 and ch7. FIG. 13C is a diagram showing a distribution of a case where the other populations in cytogram C2 for ch6 and ch7 are classified into populations B and C and displayed.

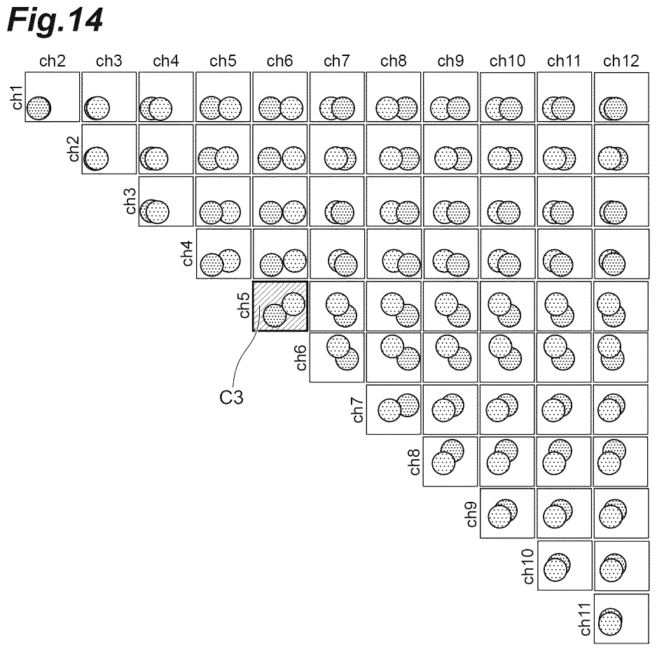

FIGS. 14 to 17C are explanatory diagrams of a process of the third cycle within the iterative processing of the first determination step S1 and the first separation step S2.

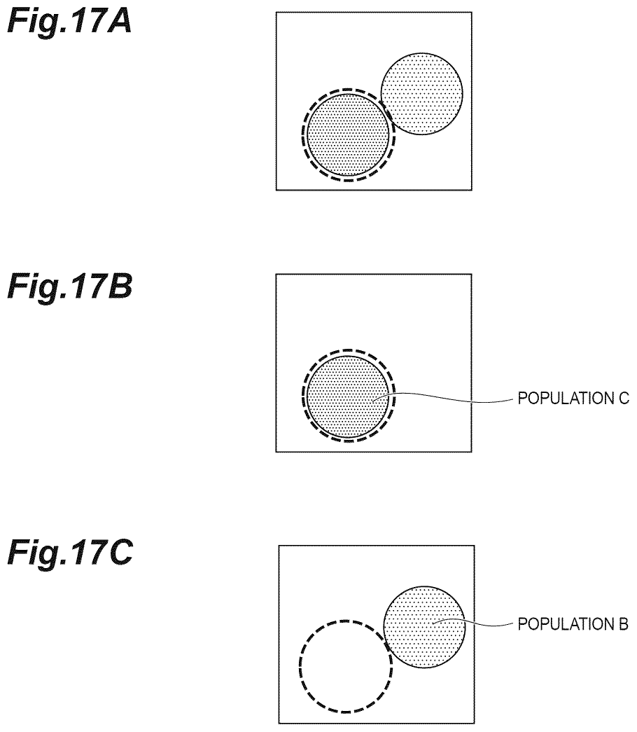

FIG. 14 is a diagram showing a cytogram of measurement data before the arithmetic process (except for the measurement data of populations X and Y (populations A to D), which have already been separated). This drawing also shows cytograms for all combinations of two detection channels selected from among the 12 detection channels. As shown in this drawing, in the display of a cytogram (e.g., in FIG. 14, cytogram C3 in which the measurement data for ch5 and ch6 is plotted on a two-dimensional map), the two populations (here populations B and C) do not overlap each other and can be separated from each other (FIGS. 17A to 17C). Therefore, in the first determination step S1, it is determined that the two populations can be separated into different populations on the display of the cytograms for ch5 and ch6. Also, in the first separation step S2, one population (here, population C) is separated from the two populations.

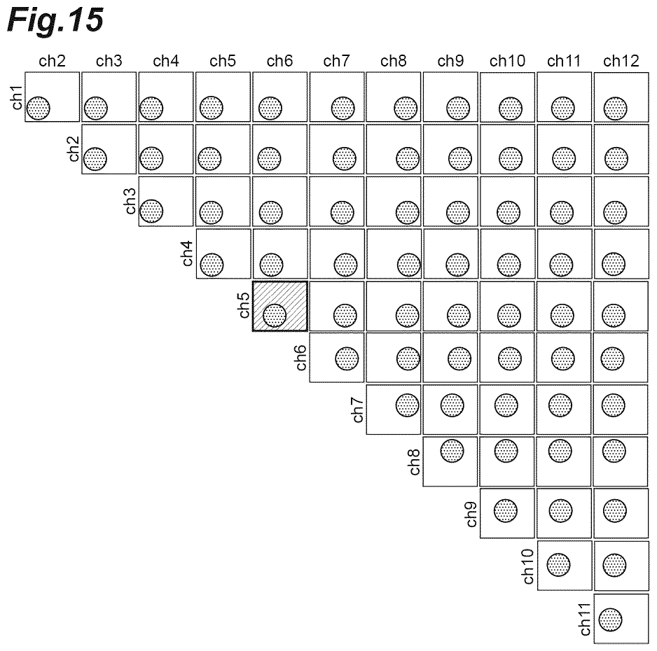

FIG. 15 is a diagram showing a cytogram of the measurement data for the separated population C. This drawing also shows cytograms for all combinations of two detection channels selected from among the 12 detection channels. On the display of these cytograms, it is possible to confirm that there is only one population (in this case, population C), because there is no recognition of the presence of a plurality of populations.

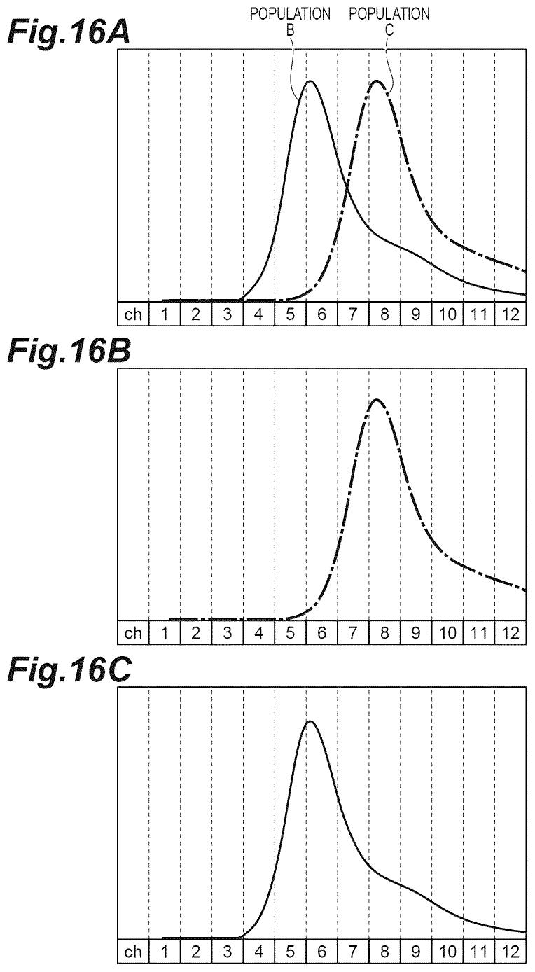

FIG. 16A is a diagram showing fluorescence spectra of two populations B and C. FIG. 16B is a diagram showing a fluorescence spectrum of only the separated population C. FIG. 16C is a diagram showing a fluorescence spectrum of the other population B. FIG. 17A is a diagram showing a distribution of a case where two populations in cytogram C3 for ch5 and ch6 are classified into populations B and C and displayed. FIG. 17B is a diagram showing a distribution of only one population (population C) in cytogram C3 for ch5 and ch6. FIG. 17C is a diagram showing a distribution of the other population (population B) in cytogram C3 for ch5 and ch6.

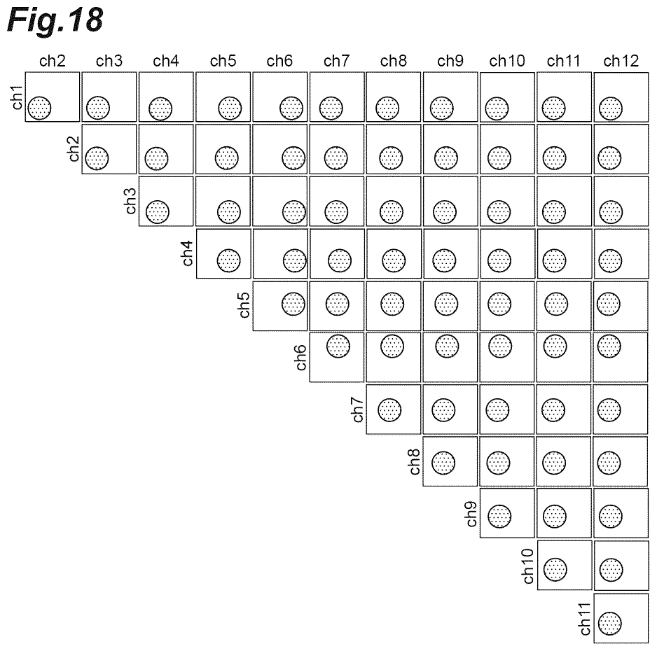

FIG. 18 is a diagram showing a cytogram of measurement data in a fourth cycle (except for the measurement data of populations A, C, and D, which have already been separated). This drawing also shows cytograms for all combinations of two detection channels selected from among the 12 detection channels. As shown in this drawing, on the display of these cytograms, it is possible to confirm that there is only one population (in this case, population B), because there is no recognition of the presence of a plurality of populations. In this fourth cycle, in the first determination step S1, it is determined that no further separation of the population is possible.

In this way, the population can be separated into four individual populations (populations A to D) by the iterative processing of the first determination step S1 and the first separation step S2. The samples included in the individual populations that are determined to be unable to be further separated are discriminated as samples labeled with any of the fluorescent dyes. Also, in the identification step S5, the samples discriminated to be labeled with any of the fluorescent dyes are identified based on the fluorescence spectra obtained from the measurement data of a plurality of detection channels. In other words, in practice, as a result of the identification step S5, it is possible to identify which of the populations A to D the individually separated population is.

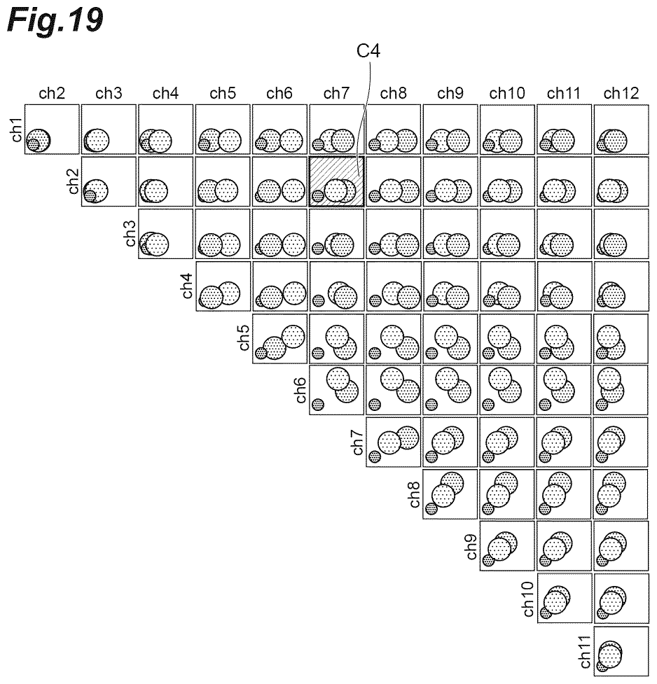

Next, the fluorescence analysis method shown in FIG. 3 will be further described using FIGS. 19 to 21B. Here, a case where a process different from that in the second cycle described above is performed after a process identical to that in the first cycle described above will be described.

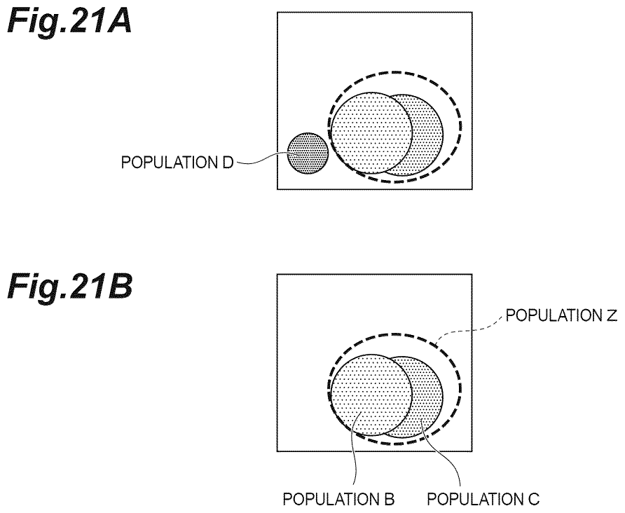

FIG. 19 is a diagram showing a cytogram of the measurement data before the arithmetic process (except for the measurement data of population X (population A), which has already been separated). This drawing is similar to the cytogram shown in FIG. 10, but we shall focus on cytogram C4 for ch2 and ch7. In the display of cytogram C4 for ch2 and ch7, populations B, C and D do not overlap each other and can be separated from each other (FIGS. 21A and 21B). However, in the display of cytogram C4, because populations B and C overlap each other, they are apparently displayed as a single population Z. Therefore, in the first determination step S1, it is determined that separation into population Z (populations B and C) and population D is possible on the display of cytogram C4 for ch2 and ch7. Also, in the first separation step S2, one apparent population Z is separated from the two populations, including populations B and C.

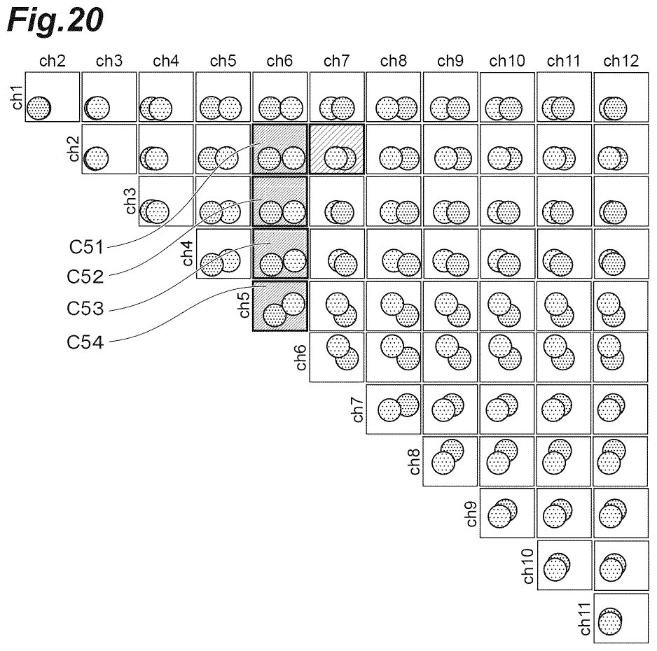

FIG. 20 is a diagram showing a cytogram of measurement data of a separated population Z (one apparent population including populations B and C). Looking at cytogram C51 for ch2 and ch6, cytogram C52 for ch3 and ch6, cytogram C53 for ch4 and ch6, and cytogram C54 for ch5 and ch6, it can be seen from these displays that the population Z separated in the first separation step S2 can in fact be separated into two populations. Therefore, in the second determination step S3, it is determined that the population Z separated in the first separation step S2 can be further separated into a plurality of populations. Also, in the second separation step S4, any one of the plurality of populations is separated. It is only necessary to iteratively perform the second determination step S3 and the second separation step S4.

FIG. 21A is a diagram showing a distribution of a case where a plurality of populations in cytogram C4 for ch2 and ch7 are classified into three populations B to D and displayed. FIG. 21B is a diagram showing a distribution of one apparent population Z including populations B and C in cytogram C4 for ch2 and ch7.

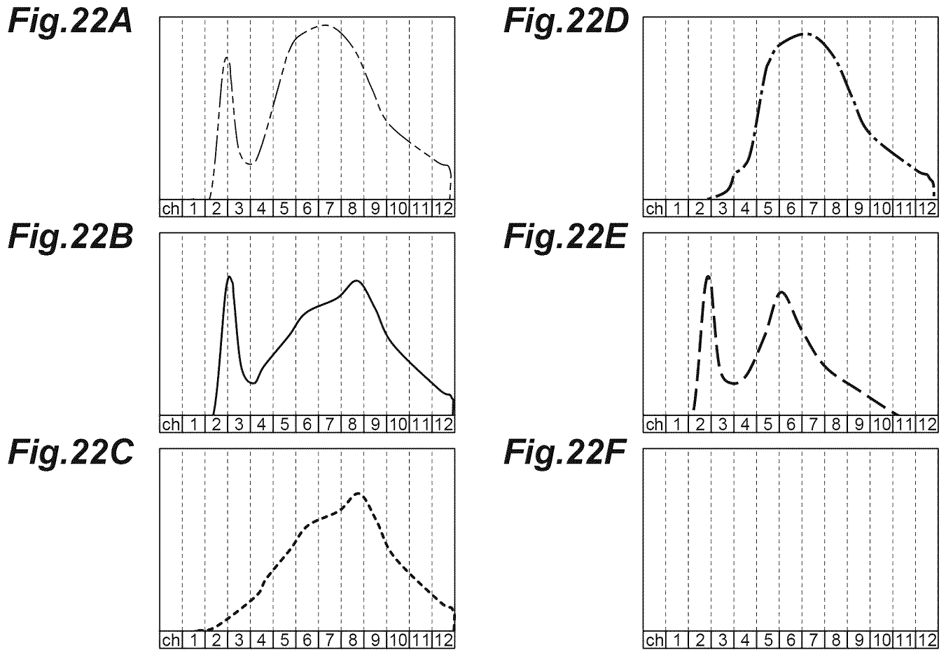

Next, the processing of the identification step S5 will be described with reference to FIGS. 22A to 24D. In the identification step S5, identification is performed based on the fluorescence spectra obtained from the measurement data by the plurality of detection channels for fluorescence detection for the samples included in the population that is determined to be unable to be further separated in the first determination step S1 or the second determination step S3. It is assumed that each sample included in one population is similarly labeled with a fluorescent dye. Samples may not be labeled with any fluorescent dyes, may be labeled with only one of a plurality of fluorescent dyes, or may be labeled with two or more fluorescent dyes. Moreover, when the sample is labeled with two or more fluorescent dyes, the number of fluorescent dyes may vary with the type of fluorescent dye. The fluorescence spectrum measured for each sample included in one population will depend on the type and number of fluorescent dyes with which each sample is labeled.

In the identification step S5, the type and number of fluorescent dyes with which each sample is labeled are identified. As a method of identification, a case where the identification is directly performed from the contrast between the fluorescence spectra of various types of fluorescent dyes and a case where the identification is performed according to an arithmetic process are conceivable. In the former case, high-speed processing is possible because no arithmetic process is performed. On the other hand, as described below in FIGS. 22A to 24D, when the relationship between the sample and the fluorescent dye can take various forms, it is often difficult to identify the sample without performing an arithmetic process. There are various methods for the arithmetic process, such as fluorescence correction or fluorescence intensity calculation. More specifically, for example, there is a method in which the fluorescence spectra of various types of fluorescent dyes are obtained in advance and used as a reference for fitting, or a method that does not require the use of a reference (see Japanese Patent No. 7564408). Hereinafter, the identification method based on fitting using a reference will be described as an example. Here, it is assumed that three types of fluorescent dyes A to C are used, and these fluorescence spectra (reference) are as shown in FIG. 4. Moreover, it is assumed that the population has been separated into six populations in the first separation step S2 or the second separation step S4.

FIGS. 22A to 22F are diagrams showing fluorescence spectra of six separated populations. Among these fluorescence spectra, the fluorescence spectra in FIGS. 22A to 22E are different from the fluorescence spectra shown in FIG. 4, and therefore represent fluorescence generated in samples labeled with two or more types of fluorescent dyes. The fluorescence spectrum in FIG. 22F shows the autofluorescence of a sample that is not labeled with any fluorescent dyes, because no fluorescence from the fluorescent dyes is observed.

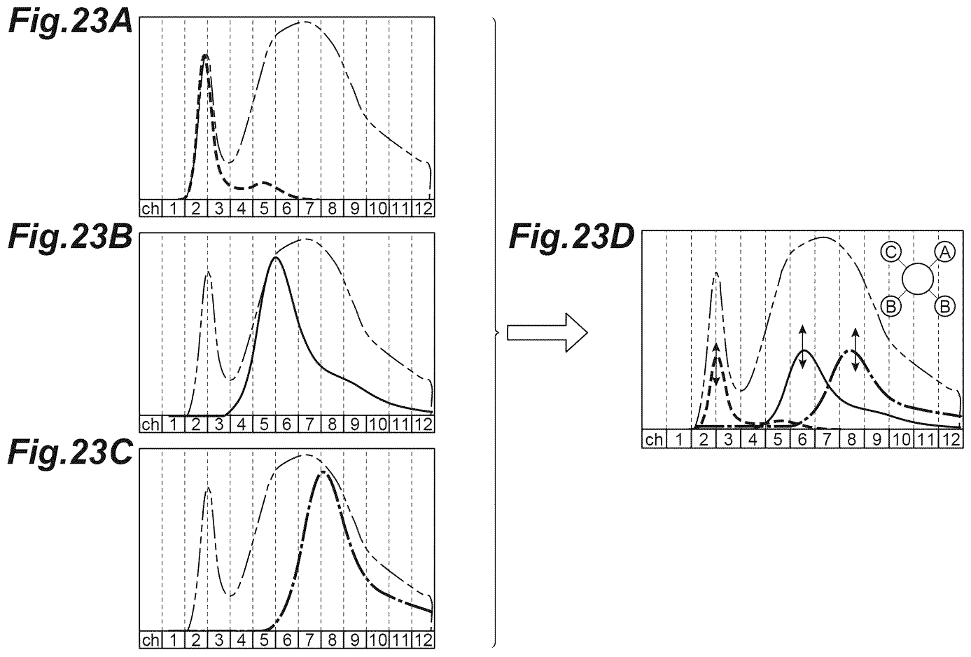

FIG. 23A is a diagram showing the fluorescence spectrum of FIG. 22A and the fluorescence spectrum (reference) of fluorescent dye A in FIG. 4. FIG. 23B is a diagram showing the fluorescence spectrum of FIG. 22A and the fluorescence spectrum (reference) of fluorescent dye B in FIG. 4. FIG. 23C is a diagram showing the fluorescence spectrum of FIG. 22A and the fluorescence spectrum (reference) of fluorescent dye C in FIG. 4. The fluorescence spectrum in FIG. 22A is a composite spectrum represented by a linear sum of the fluorescence spectra (reference) of fluorescent dyes A to C. Although the composite spectrum is a linear sum of the fluorescence spectrum (reference) with the addition of the sample's autofluorescence in reality, the effect of the sample's autofluorescence is assumed to be absent (or not to be considered) as described above for simplicity of description in the present embodiment. If the fitting process is performed using this, it can be seen that the samples in this population are labeled with one fluorescent dye A, two fluorescent dyes B, and one fluorescent dye C (FIG. 23D).

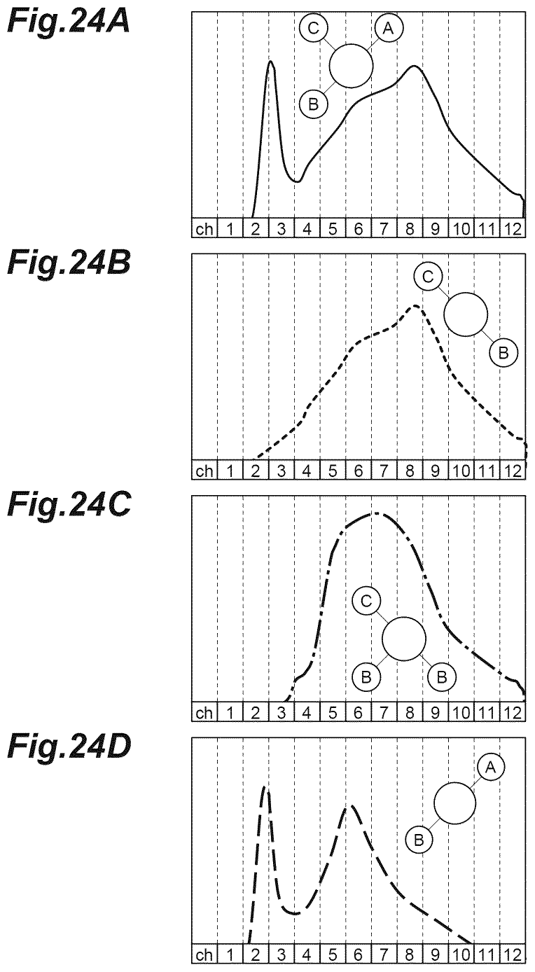

When a similar fitting process is performed, it can be seen that the samples included in the population showing the fluorescence spectrum in FIG. 22B are labeled with one fluorescent dye A, one fluorescent dye B, and one fluorescent dye C (FIG. 24A). It can be seen that the samples included in the population showing the fluorescence spectrum in FIG. 22C are labeled with one fluorescent dye B and one fluorescent dye C (FIG. 24B). It can be seen that the samples included in the population showing the fluorescence spectrum in FIG. 22D are labeled with two fluorescent dyes B and one fluorescent dye C (FIG. 24C). It can be seen that the samples included in the population showing the fluorescence spectrum in FIG. 22E are labeled with one fluorescent dye A and one fluorescent dye B (FIG. 24D).

As described above, in the present embodiment, population separation is performed as much as possible using the measurement data before the arithmetic processing, and then identification is carried out based on the fluorescence spectrum of the samples of each separated population. Therefore, variations in measurement data due to the arithmetic process can be suppressed and analysis accuracy can be improved. In addition, the restrictions imposed by the fluorescence intensity and fluorescence wavelength bands are mitigated and the number of available fluorescent dyes can be increased.

What is claimed is:

1. A fluorescence analysis device for discriminating samples in accordance with a type of fluorescent dye labeled by analyzing measurement data before an arithmetic process obtained by detecting fluorescence generated when a plurality of samples labeled with any of a plurality of fluorescent dyes are each irradiated with excitation light by a plurality of detection channels, the fluorescence analysis device comprising:
a first determination unit configured to determine whether or not the plurality of samples can be separated into two or more populations based on the measurement data by any one or more of the plurality of detection channels; and
a first separation unit configured to separate one population from the two or more populations when the first determination unit determines that the plurality of samples can be separated into the two or more populations,
wherein a process of each of the first determination unit and the first separation unit is iteratively performed for a plurality of samples other than an already discriminated sample until the first determination unit determines that the plurality of samples cannot be separated into the two or more populations and a sample included in a population whose separation is determined to be impossible is discriminated as a sample labeled with any fluorescent dye.

2. The fluorescence analysis device according to claim 1, further comprising:
a second determination unit configured to determine whether or not a plurality of samples included in a separated population can be further separated into two or more populations based on measurement data of any one or more of the plurality of detection channels; and
a second separation unit configured to separate one population from the two or more populations when the second determination unit determines that the plurality of samples can be separated into the two or more populations,
wherein a process of each of the second determination unit and the second separation unit is iteratively performed for a plurality of samples other than an already discriminated sample until the second determination unit determines that the plurality of samples cannot be separated into the two or more populations and a sample included in a population whose separation is determined to be impossible is discriminated as a sample labeled with any fluorescent dye.

3. The fluorescence analysis device according to claim 1, further comprising an identification unit configured to perform an identification process based on a fluorescence spectrum obtained from the measurement data by the plurality of detection channels for a sample discriminated to be labeled with any fluorescent dye.

4. The fluorescence analysis device according to claim 1, wherein the first determination unit performs the determination based on the measurement data obtained by detecting the fluorescence generated when each of a plurality of samples labeled with any of a plurality of fluorescent dyes is irradiated with excitation light of a plurality of wavelengths by a plurality of detection channels.

5. The fluorescence analysis device according to claim 1, wherein the first determination unit performs the determination after a binning process is performed on the measurement data.

6. A fluorescence analysis method for discriminating samples in accordance with a type of fluorescent dye labeled by analyzing measurement data before an arithmetic process obtained by detecting fluorescence generated when a plurality of samples labeled with any of a plurality of fluorescent dyes are each irradiated with excitation light by a plurality of detection channels, the fluorescence analysis method comprising:
a first determination step of determining whether or not the plurality of samples can be separated into two or more populations based on the measurement data by any one or more of the plurality of detection channels; and
a first separation step of separating one population from the two or more populations when it is determined that the plurality of samples can be separated into the two or more populations in the first determination step,
wherein the first determination step and the first separation step are iteratively performed for a plurality of samples other than an already discriminated sample until it is determined that the plurality of samples cannot be separated into the two or more populations in the first determination step and a sample included in a population whose separation is determined to be impossible is discriminated as a sample labeled with any fluorescent dye.

7. The fluorescence analysis method according to claim 6, further comprising:
a second determination step of determining whether or not a plurality of samples included in a separated population can be further separated into two or more populations based on measurement data of any one or more of the plurality of detection channels; and
a second separation step of separating one population from the two or more populations when the second determination step determines that the plurality of samples can be separated into the two or more populations,
wherein the second determination step and the second separation step are iteratively performed for a plurality of samples other than an already discriminated sample until it is determined that the plurality of samples cannot be separated into the two or more populations in the second determination step and a sample included in a population whose separation is determined to be impossible is discriminated as a sample labeled with any fluorescent dye.

8. The fluorescence analysis method according to claim 6, further comprising an identification step of performing an identification process based on a fluorescence spectrum obtained from the measurement data by the plurality of detection channels for a sample discriminated to be labeled with any fluorescent dye.

9. The fluorescence analysis method according to claim 6, wherein the first determination step includes performing the determination based on the measurement data obtained by detecting the fluorescence generated when each of a plurality of samples labeled with any of a plurality of fluorescent dyes is irradiated with excitation light of a plurality of wavelengths by a plurality of detection channels.

10. The fluorescence analysis method according to claim 6, wherein the first determination step includes performing the determination after a binning process is performed on the measurement data.
